(19) United States
(12) Patent Application Publication
(10) Pub. No.: US 2008/0116704 A1
(43) Pub. Date: May 22, 2008

(54) Sanitary pet urine collection apparatus

(76) Inventors: Andres Botello, Irving, TX (US); Victor M. Sotomayor, Bedford, TX (US)

Correspondence Address: Michael Cameron, Esq., 2025 Savannah Drive, McKinney, TX, 75070, US

(21) Appl. No.: 11/985,472

(22) Filed: Nov. 15, 2007

Related U.S. Application Data
(60) Provisional application No. 60/860,015, filed on Nov. 20, 2006.

(51) Int. Cl. A01K 29/00

(52) U.S. Cl. 294/1.5

(57) ABSTRACT

What is disclosed is an apparatus adapted to collect an uncontaminated urine specimen, comprising a pole having a grip on a first end and a coupling means at a second end, and a bowl, such as a flat bottomed, stainless steel bowl, adapted to be coupled to the second end.

### CROSS REFERENCE TO RELATED APPLICATION

This application claims the benefit of U.S. Provisional Application No. 60/860,015 filed on Nov. 16, 2006, entitled “SANITARY PET URINE COLLECTION APPARATUS.”

### TECHNICAL FIELD

The present invention relates to pet urine collection devices, as used, for example, in a veterinary clinic.

### BACKGROUND OF THE INVENTION

Often, in a veterinary clinic, it is necessary to obtain a urine sample from an animal in order to run diagnostic tests such as urinalysis. Often, paper cups or short handled soup ladles are used to perform this task. What is desired is an apparatus that is adapted to collect urine from dogs, male or female, in a manner that will not scare the dog (in which case it will stop urinating). Such an apparatus should be sanitary for the person collecting the specimen and able to collect the sample without contamination.

### SUMMARY OF THE INVENTION

The present invention comprises an apparatus adapted to collect an uncontaminated urine specimen. The present invention allows a technician to set the container element of the present invention on a counter, to perform a urinalyses, without it falling over and spilling the specimen. By using the present invention, it avoids the disadvantages associated with conventional collection methods, such as: (1) contaminated urine specimens due to dogs stepping in the urine while confined in a cage; (2) the need to chase a dog with a small paper cup or a soup ladle to collect a urine specimen; (3) the need to get close to the dog which results in a the dog refusing to urinate; (4) getting sprayed with urine on the technicians hands while attempting to get a specimen with a paper cup; (5) the need to bend and stoop hence getting back strain; and (6) lost specimens due to spilling when the soup ladle falls over because of its round bottom.

To those skilled in the art to which this invention relates, many changes in construction and widely differing embodiments and applications of the invention will suggest themselves without departing from the scope of the invention as defined in the appended claim. The disclosures and the descriptions herein are purely illustrative and are not intended to be in any sense limiting.

### BRIEF DESCRIPTION OF THE DRAWINGS

For a better understanding of the present invention including the features, advantages and specific embodiments, reference is made to the following detailed description along with accompanying drawings in which:

FIG. 1 is a first view of the apparatus of the present invention;

FIG. 2 is a view of the apparatus of the present invention with the bowl separated from the pole;

FIG. 3 is a first view of the bowl of the present invention;

FIG. 4 is a second view of the bowl of the present invention;

FIG. 5 is a first view of the plastic side release buckle of the present invention;

FIG. 6 is a second view of the plastic side release buckle of the present invention;

FIG. 7 is another view of the apparatus of the present invention;

FIG. 8 is a third view of the bowl of the present invention; and

FIG. 9 is a fourth view of the bowl of the present invention.

References in the detailed description correspond to like references in the Figures unless otherwise noted. Like numerals refer to like parts throughout the various Figures.

### DETAILED DESCRIPTION OF A PREFERRED EMBODIMENT

While the making and using of the preferred embodiment of the present invention is discussed in detail below, it should be appreciated that the present invention provides many applicable inventive concepts which can be embodied in a wide variety of specific contexts. Some features of the preferred embodiment shown and discussed may be simplified or exaggerated for illustrating the principles of the invention.

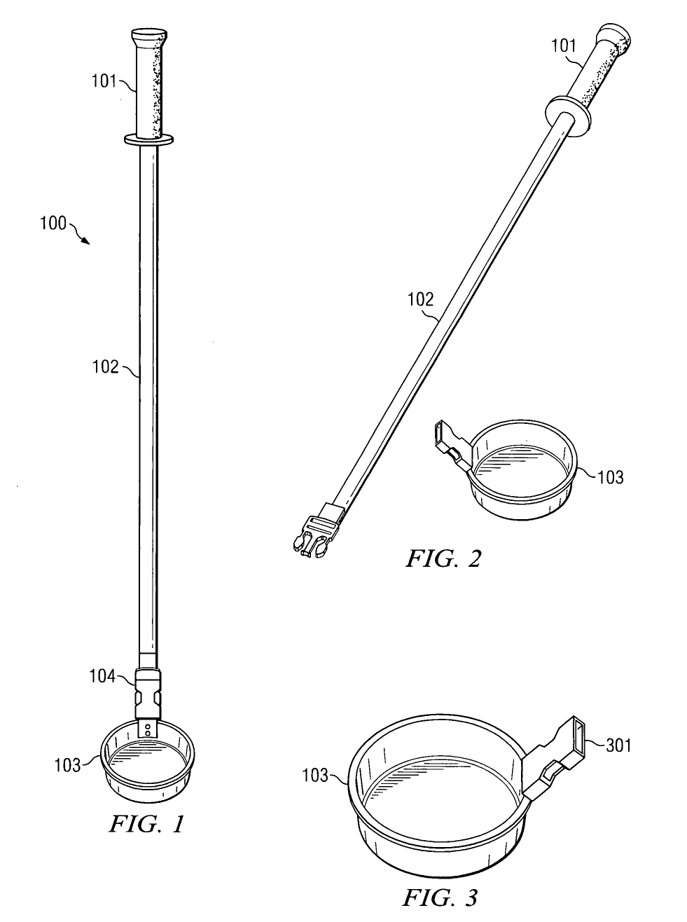

Referring now to FIG. 1, a first view of the apparatus of the present invention is provided. As seen therein, the present invention includes a pole, or alternatively referred to as a pipe or pipe handle, preferably comprising a ½ inch galvanized metal pole 102 approximately 30 inches in length. At the top end of the pole is a rubber handle grip 101. The bottom end of the pole has coupled thereto a metal strip 104, such as an aluminum strip 104 using a first coupling means 105. The first coupling means 105 includes, for example, metal or plastic rivets. Coupled to the end of the aluminum strip 104, with among other things, rivets, is a first portion of an attachment means, such as a plastic release buckle having a female end 301 and a male end 302. The second portion of the present invention is a bowl, preferably being a ½ pint, stainless steel bowl 103. Coupled, via a second coupling means, to a portion of the lip of the bowl is the female end 301 of the plastic side release buckle. Said second coupling means includes metal or plastic rivets. The bowl 103 attaches to the pole 102 by means of the plastic side release buckle 301, 302. The bowl 103 is adapted to be detached from the pipe 102 and stand on its own. For example, said bowl 103 is substantially flat bottomed, and can be made from any one of a plurality of materials, such as stainless steel or rigid, urine resistant plastic. It is important that the materials used in fabricating the present invention do not chemically react with chemicals found in urine. The present invention includes variations from that described above, including a quick release clip and a telescoping handle.

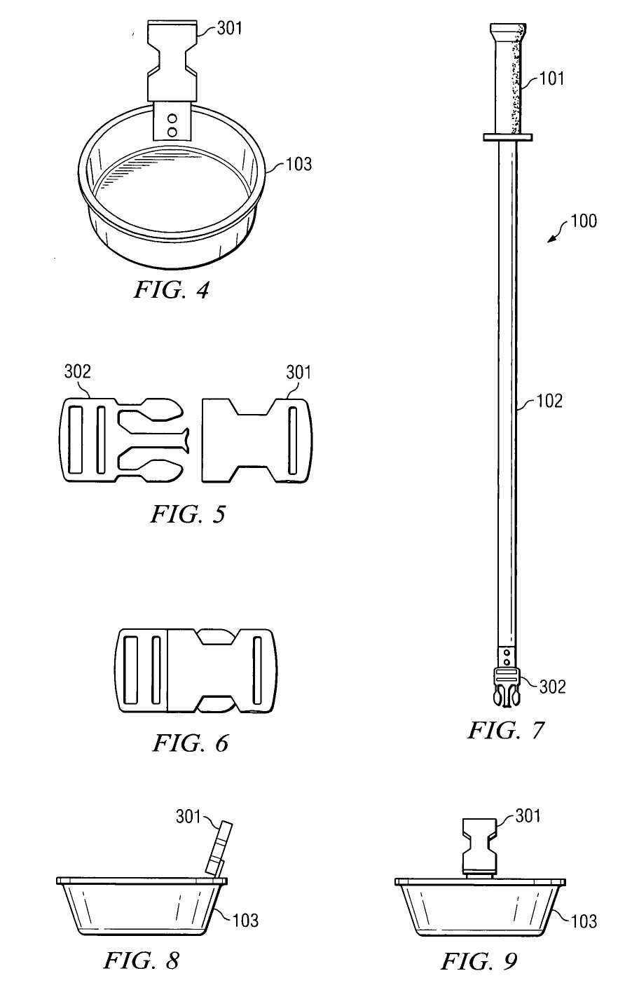

FIG. 2 is a view of the apparatus of the present invention with the bowl 103 separate from the pole 102. FIG. 3 is a first view of the bowl 103 used in the present invention. FIG. 4 is a second view of the bowl 103 used in the present invention. FIG. 5 is a first view of the plastic side release buckle 301, 302 of the present invention. FIG. 6 is a second view of the plastic side release buckle 301, 302 of the present invention. FIG. 7 is another view of the apparatus of the present invention. FIG. 8 is a third view of the bowl 103 of the present invention; and FIG. 9 is a fourth view of the bowl 103 of the present invention.

The embodiments shown and described herein are only exemplary. Even though characteristics and advantages of the present invention have been set forth in the foregoing description together with details of the invention, the disclosure is illustrative only and changes may be made within the principles of the invention to the full extent indicated by the broad general meaning of the terms used in the attached claims.

We claim:

1. An apparatus adapted to collect an uncontaminated urine specimen, comprising:
a pole with a first end and a second end;
a grip proximate the first end;
an attachment means proximate the second end; and
a bowl adapted to be coupled proximate the second end via the attachment means.

2. The apparatus of claim 1, wherein the bowl has a substantially flat bottom.

3. The apparatus of claim 2, wherein the bowl is made of a material that is chemically non-reactive with urine.

4. The apparatus of claim 3, wherein the bowl is made of stainless steel.

5. The apparatus of claim 4, wherein the bowl is adapted to hold about ½ pint of fluid.

6. The apparatus of claim 3, wherein the bowl is made of urine resistant plastic.

7. The apparatus of claim 6, wherein the bowl is adapted to hold about ½ pint of fluid.

8. The apparatus of claim 1, wherein the pole has a length of between about 12 inches and 40 inches.

9. The apparatus of claim 1, wherein the pole is telescopically collapsible.

10. The apparatus of claim 1, wherein the grip further comprises a rubber grip handle at the first end of the pole.

11. The apparatus of claim 1, wherein the attachment means comprises a plastic release buckle having a male end and a female end.

12. The apparatus of claim 11, wherein the male end is coupled to the pole via a first coupling means and the female end is coupled to the bowl via a second coupling means.

13. The apparatus of claim 12, wherein the first coupling means includes a strip attached to the pole via rivets and the second coupling means comprises rivets.

14. The apparatus of claim 1, wherein the attachment means further comprises a quick release clip.

15. The apparatus of claim 14, wherein the first coupling means includes a strip attached to the pole via rivets and the second coupling means comprises rivets.
